(19) United States
(12) Patent Application Publication
(10) Pub. No.: US 2026/0255071 A1
(43) Pub. Date: Aug. 27, 2026

(54) SIGNAL PROCESSING DEVICE, SIGNAL PROCESSING METHOD, AND PROGRAM

(71) Applicant: SONY SEMICONDUCTOR SOLUTIONS CORPORATION, KANAGAWA (JP)

(72) Inventor: GOSHI WATANABE, KANAGAWA (JP)

(21) Appl. No.: 19/162,874

(22) PCT Filed: Mar. 11, 2024
(86) PCT No.: PCT/JP2024/009273

§ 371 Date: Sep. 5, 2025

(30) Foreign Application Priority Data
Mar. 24, 2023 (JP) 2023-048347

(51) Int. Cl. H04N 23/84; H04N 23/12

(52) U.S. Cl. CPC H04N 23/84; H04N 23/12

(57) ABSTRACT

A signal processing device includes a signal processing unit that performs, for a spectral sensor image that is a spectral image obtained by light receiving operation of a spectral sensor, overall output processing of outputting pixel data of all regions and all wavelengths for the spectral sensor image obtained in a first frame period, and thinning output processing of thinning out and outputting part of pixel data for the spectral sensor image obtained in a second frame period different from the first frame period.

### TECHNICAL FIELD

The present technology relates to a signal processing device, a signal processing method, and a program, and particularly relates to a technical field related to transmission of a spectral sensor image obtained by light receiving operation of a spectral sensor.

### BACKGROUND ART

A spectral sensor (multi-spectrum sensor) is known for obtaining a plurality of narrow-band images to be a wavelength characteristic analysis image for light from a subject, in other words, an analysis image of spectral information (optical spectrum) on the subject, and an application has been developed for performing various analyses of the subject on the basis of the spectral information obtained by the spectral sensor, for example, estimating a vegetation state of a plant, estimating a human skin state, or the like, on the basis of the plurality of narrow-band images.

Since the spectral sensor image includes a large amount of pixel data similarly to, for example, a captured image or the like by an RGB sensor for obtaining a color image, an amount of transmission data tends to increase, and there is a possibility that a band of a transmission path is compressed.

Note that Patent Document 1 below can be cited as a related art. Patent Document 1 below discloses a technology for improving transmission efficiency by avoiding transmission of data of all pixels every frame by including a mode for outputting all pixels and a mode for outputting only some pixels for image data obtained by an image sensor.

### CITATION LIST

### Patent Document

Patent Document 1: WO 2020/116213 A

### SUMMARY OF THE INVENTION

### Problems to be Solved by the Invention

The present technology has been made in view of the above circumstances, and an object thereof is to improve transmission efficiency of a spectral sensor image.

### Solutions to Problems

A first signal processing device according to the present technology includes a signal processing unit that performs, for a spectral sensor image that is a spectral image obtained by light receiving operation of a spectral sensor, overall output processing of outputting pixel data of all regions and all wavelengths for the spectral sensor image obtained in a first frame period, and thinning output processing of thinning out and outputting part of pixel data for the spectral sensor image obtained in a second frame period different from the first frame period.

By performing the thinning output processing described above, it is possible to reduce an amount of transmission data of the spectral sensor image. At this time, by performing the overall output processing described above, it is possible to cause a spectral sensor image reception side to execute interpolation of thinned data by using the pixel data of all the regions and all the wavelengths transmitted in the overall output processing.

Furthermore, a second signal processing device according to the present technology includes: a reception unit that receives pixel data of all regions and all wavelengths output in overall output processing and pixel data after thinning and metadata output in thinning output processing from a signal processing device that performs, for a spectral sensor image that is a spectral image obtained by light receiving operation of a spectral sensor, the overall output processing of outputting the pixel data of all the regions and all the wavelengths for the spectral sensor image obtained in a first frame period, and the thinning output processing of thinning out and outputting part of pixel data for the spectral sensor image obtained in a second frame period different from the first frame period and outputting metadata indicating interpolation data for the pixel data after the thinning as the metadata of the pixel data after the thinning; and an interpolation unit that performs interpolation processing on the pixel data after the thinning on the basis of the pixel data of all the regions and all the wavelengths and the metadata received by the reception unit.

As a result, it is possible to perform interpolation of thinned data corresponding to a case where the pixel data of the spectral sensor image is thinned to reduce the amount of transmission data.

### BRIEF DESCRIPTION OF DRAWINGS

FIG. 1 is a block diagram illustrating a schematic configuration example of a spectral camera including a signal processing device as a first embodiment.

FIG. 2 is a diagram schematically illustrating a configuration example of a pixel array unit included in the spectral sensor.

FIG. 3 is an explanatory diagram of band narrowing processing in an embodiment.

FIG. 4 is an explanatory diagram of a thinning method and an interpolation method as the first embodiment.

FIG. 5 is an explanatory diagram of an example of metadata in the embodiment.

FIG. 6 is a flowchart illustrating an example of a processing procedure for implementing the thinning method as the first embodiment.

FIG. 7 is a flowchart illustrating an example of a processing procedure for implementing the interpolation method as the first embodiment.

FIG. 8 is an explanatory diagram of an example of a transmission method for a spectral sensor image.

FIG. 9 is an explanatory diagram of another example of the transmission method for the spectral sensor image.

FIG. 10 is a block diagram illustrating a schematic configuration example of a spectral camera including a signal processing device as a second embodiment.

FIG. 11 is a diagram for explaining a detection example of a region of a moving subject.

FIG. 12 is a flowchart illustrating an example of a processing procedure for implementing a thinning method as the second embodiment.

FIG. 13 is a block diagram illustrating a schematic configuration example of a spectral camera as a third embodiment.

FIG. 14 is a flowchart illustrating an example of a processing procedure for implementing a thinning method as the third embodiment.

FIG. 15 is a block diagram illustrating a schematic configuration example of a spectral camera that performs AE detection on a spectral sensor image before thinning processing is performed.

FIG. 16 is a diagram for explaining an example of an AE detection frame.

FIG. 17 is a block diagram illustrating a schematic configuration example of a signal processing device as a modification.

FIG. 18 is an explanatory diagram of an example of performing thinning by image size reduction only for a specific wavelength.

### MODE FOR CARRYING OUT THE INVENTION

Hereinafter, embodiments according to the present technology will be described in the following order with reference to the accompanying drawings.

### <1. First Embodiment>

### [1-1. Configuration of Spectral Camera]

### [1-2. Thinning and Interpolation Methods as First Embodiment]

### <2. Second Embodiment>

### <3. Third Embodiment>

### <4. Fourth Embodiment>

### <5. Modification>

### <6. Program>

### <7. Summary of Embodiments>

### <8. Present Technology>

### 1. First Embodiment

### [1-1. Configuration of Spectral Camera]

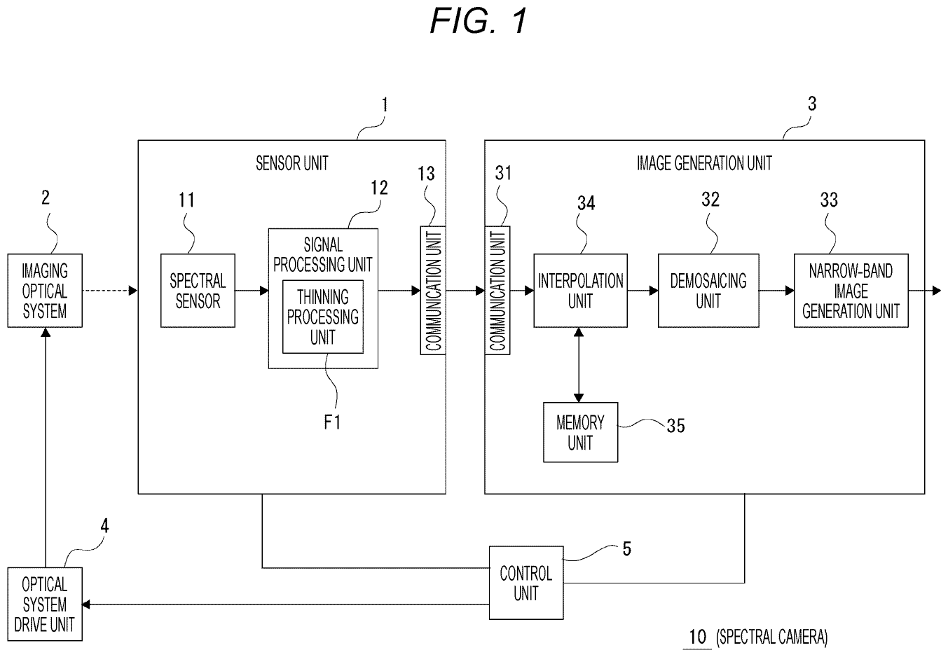

FIG. 1 is a block diagram illustrating a schematic configuration example of a spectral camera 10 as a first embodiment including a signal processing device as the first embodiment according to the present technology.

Here, the “spectral camera” means a camera including a spectral sensor as a light receiving sensor. The “spectral sensor” is a light receiving sensor for obtaining a plurality of narrow-band images to be a wavelength characteristic analysis image for light from a subject.

Note that the “light receiving sensor” means a sensor including a photoelectric conversion element as a sensing element.

As illustrated, the spectral camera 10 includes a sensor unit 1, an imaging optical system 2, an image generation unit 3, an optical system drive unit 4, and a control unit 5.

The sensor unit 1 includes a spectral sensor 11, a signal processing unit 12, and a communication unit 13.

Light from a subject enters the spectral sensor 11 through the imaging optical system 2.

The imaging optical system 2 includes various optical elements including a lens such as a focus lens, a diaphragm mechanism, and the like.

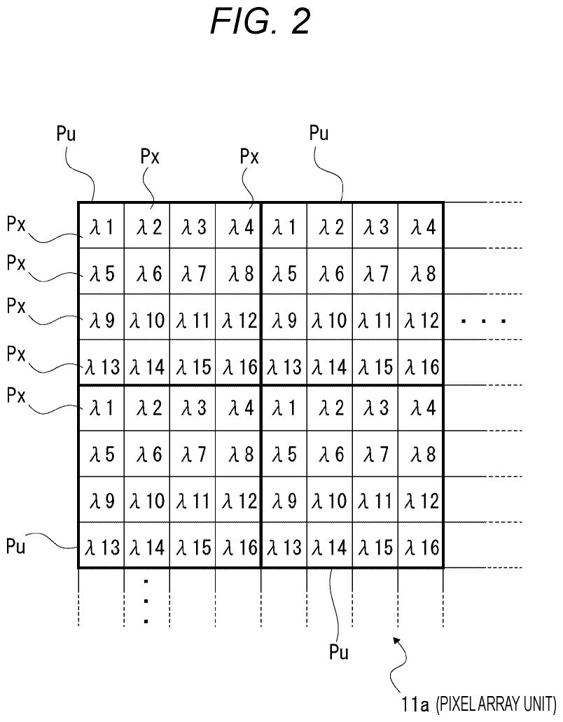

A configuration example of a pixel array unit 11a included in the spectral sensor 11 will be described with reference to a schematic diagram of FIG. 2.

As illustrated, in the pixel array unit 11a, a spectral pixel unit Pu is formed in which a plurality of pixels Px respectively receiving light of different wavelength bands is two-dimensionally arranged in a predetermined pattern. The pixel array unit 11a includes a plurality of spectral pixel units Pu arranged two-dimensionally.

The example in the drawing illustrates an example in which each of the spectral pixel units Pu receives light of a total of 16 wavelength bands of λ1 to λ16 in the respective pixels Px, in other words, an example in which the number of wavelength bands selectively received in each of the spectral pixel units Pu (hereinafter referred to as “the number of receiving wavelength channels”) is “16”, but this is merely an example for description, and the number of receiving wavelength channels in the spectral pixel unit Pu is only required to be at least a plural number, and can be arbitrarily set.

Hereinafter, the number of receiving wavelength channels in the spectral pixel unit Pu is defined as “N”.

In FIG. 1, a spectral image (hereinafter referred to as a “spectral sensor image”) obtained by light receiving operation of the spectral sensor 11 is input to the signal processing unit 12. The signal processing unit 12 performs various types of necessary signal processing such as gain adjustment processing on the spectral sensor image output from the spectral sensor 11, and outputs the resultant image.

The signal processing unit 12 in the present embodiment has a function as a thinning processing unit F1, but the thinning processing unit F1 will be described later again.

The communication unit 13 is a communication device for transmitting the spectral sensor image to the outside of the sensor unit 1, and in the present example, for example, a communication device compatible with the mobile industry processor interface (MIPI) communication standard is used.

The image generation unit 3 generates M narrow-band images on the basis of the spectral sensor image input from the sensor unit 1. Here, it is assumed that “M>N”, and for example, M=48 or the like with respect to N=16.

The image generation unit 3 includes a communication unit 31, a demosaicing unit 32, and a narrow-band image generation unit 33, and also includes an interpolation unit 34 and a memory unit 35 in the present embodiment.

The communication unit 31 is a communication device for performing data communication with the communication unit 13 of the sensor unit 1, and is configured as a communication device compatible with the same communication standard as the communication unit 13, specifically, the MIPI communication standard in the present example.

Here, a description will be given assuming that thinning processing to be described later is not performed on the sensor unit 1 side, and pixel data (pixel value: luminance value in the present specific example) of all regions and all wavelengths of the spectral sensor image is transmitted to the communication unit 31.

The spectral sensor image transmitted to the communication unit 31 is input to the demosaicing unit 32 through the interpolation unit 34.

The demosaicing unit 32 performs demosaicing processing on the spectral sensor image.

The narrow-band image generation unit 33 performs band narrowing processing (linear matrix processing) based on wavelength band images for N channels obtained by the demosaicing processing, thereby generating the M narrow-band images from the N wavelength band images.

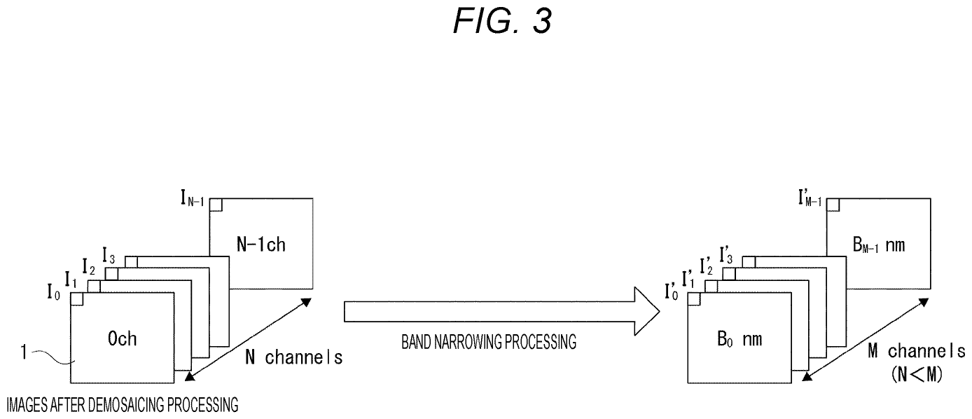

FIG. 3 is an explanatory diagram of the band narrowing processing for obtaining the M narrow-band images.

On the basis of the wavelength band images for the N channels obtained by the demosaicing processing by the demosaicing unit 32, a predetermined matrix operation is performed for each of pixel positions to obtain the narrow-band images for M channels. The band narrowing processing is processing of obtaining pixel values (in the drawing, I′₀ to I′_{M-1}) for the M channels by the matrix operation using the pixel values (in the drawing, I₀ to I_{N-1}) for the N channels for each pixel position, in order to convert the wavelength band images for the N channels into the narrow-band images for the M channels in this manner.

Here, when a pixel value after the demosaicing processing is R, an input wavelength channel is n (0 to N−1), a band narrowing coefficient is C, an output pixel value by the narrowing processing is B, and an output wavelength channel is m (0 to M−1), an arithmetic expression of the band narrowing processing can be expressed by [Expression 1] below.

$$\begin{matrix}[ Math . 1 ] & \\ Bm = {\sum }_{n = 0}^{N - 1} ( R [ n ] * Cm [ n ] ) & [ Expression 1 ]\end{matrix}$$

That is, a pixel value B₀ of the (m=0)th output wavelength channel=R[0]×C₀[0]+R[1]×C₀[1]+R[2]×C₀[2]+, . . . +R[N−1]×C₀[N−1], and a pixel value B₁ of the (m=1)th output wavelength channel=R[0]×C₁[0]+R[1]×C₁[1]+R[2]×C₁[2]+, . . . +R[N−1]×C₁[N−1].

Thereafter, similarly, a pixel value B_{M-1} of the last (m=M−1)th output wavelength channel=R[0]×C_{M-1}[0]+R[1]×C_{M-1}[1]+R[2]×C_{M-1}[2]+, . . . +R[N−1]×C_{M-1}[N−1].

At this time, as the band narrowing coefficient C, a total of N×M coefficients are used of C₀[0] to C₀[N−1] for obtaining the pixel value B₀, C₁[0] to C₁[N−1] for obtaining the pixel value B₁, . . . , and C_{M-1}[0] to C_{M-1}[N−1] for obtaining the pixel value B_{M-1}.

Returning to FIG. 1, the control unit 5 includes a microcomputer including, for example, a central processing unit (CPU), a read only memory (ROM), a random access memory (RAM), and the like, and performs overall control of the spectral camera 10 by the CPU executing processing based on, for example, a program stored in the ROM or a program loaded in the RAM.

For example, the control unit 5 instructs the sensor unit 1 and the image generation unit 3 to execute various operations and stop the operations.

The control unit 5 also performs control for auto focus (AF) and auto exposure (AE).

Here, the optical system drive unit 4 is provided with an actuator for driving the focus lens and an actuator for driving the diaphragm mechanism, provided in the imaging optical system 2, and the control unit 5 implements AF control and AE control by controlling these actuators provided in the optical system drive unit 4. The AE control includes not only control of the diaphragm mechanism but also shutter speed control of the spectral sensor 11.

Note that, although not illustrated in FIG. 1, in a case where the AF control or the AE control is implemented, the sensor unit 1 is provided with a detection unit that performs detection for AF or AE, and the control unit 5 performs the AF or AE control on the basis of a detection result by the detection unit.

### [1-2. Thinning and Interpolation Methods as First Embodiment]

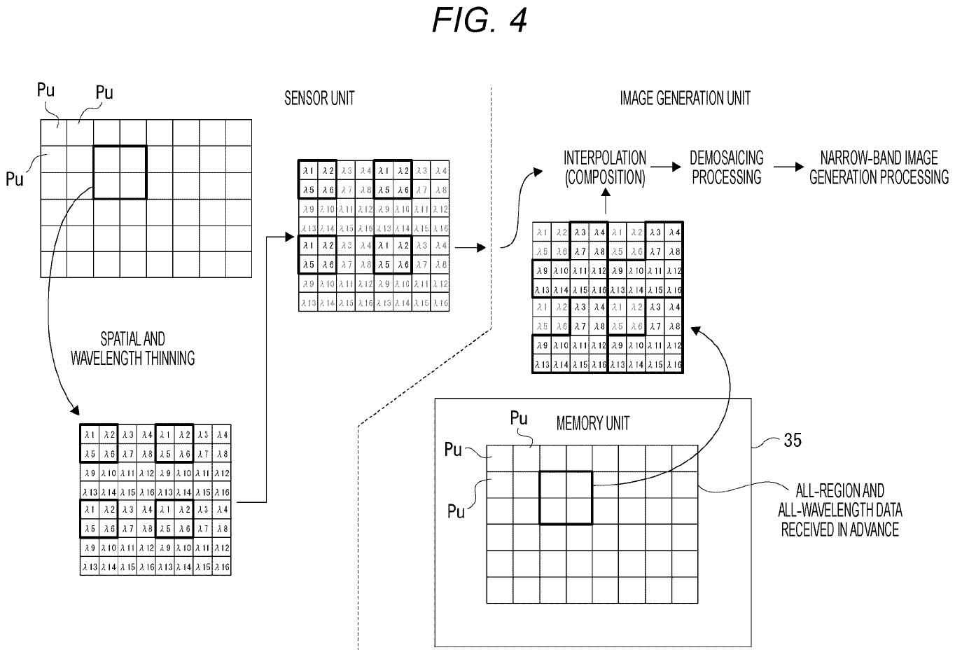

FIG. 4 is an explanatory diagram of a thinning method and an interpolation method as the first embodiment.

In the present embodiment, the signal processing unit 12 performs, for the spectral sensor image obtained by the spectral sensor 11, overall output processing of outputting pixel data of all regions and all wavelengths for the spectral sensor image obtained in a first frame period, and thinning output processing of thinning out and outputting part of pixel data for the spectral sensor image obtained in a second frame period different from the first frame period.

In the signal processing unit 12, a function of performing thinning in the thinning output processing described above corresponds to the function of the thinning processing unit F1 described above.

The signal processing unit 12 in the present example periodically performs the overall output processing described above at an interval of at least one frame. In other words, the overall output processing is performed at intervals of s (s is a natural number of greater than or equal to 1) frames. In a frame period in which the overall output processing is performed, the pixel data is output of all the regions and all the wavelengths of the spectral sensor image obtained by the spectral sensor 11 in the frame period.

Note that the overall output processing is not limited to being periodically performed, and may be executed at aperiodic intervals.

In a case where the pixel data of all the regions and all the wavelengths output in the overall output processing is received through the communication unit 31, the image generation unit 3 stores the received pixel data of all the regions and all the wavelengths in the memory unit 35 (see “all-region and all-wavelength data received in advance” in FIG. 4).

Furthermore, the signal processing unit 12 executes the thinning output processing described above in each of frames in which the overall output processing is not executed. In a frame period in which the thinning output processing is executed, part of pixel data is thinned out and output for the spectral sensor image obtained by the spectral sensor 11 in the frame period.

The signal processing unit 12 in the present example performs both wavelength thinning and spatial thinning as thinning of the spectral sensor image.

In the drawing, as an illustrative example, an example is illustrated in which only some image regions each including 2×2=4 spectral pixel units Pu in the spectral sensor image are determined as image regions of output targets (transmission targets), and then only pixel data of some wavelengths in the image regions of the output targets, specifically, only pixel data of four types of wavelengths, λ1, λ2, λ5, and λ6, are determined as output targets, and only pixel data of the output targets are output (transmitted) to the image generation unit 3 side.

Here, in a case where the spatial thinning is performed, it is conceivable that an image region to be transmitted is, for example, a region indicated from the outside. For example, in a case where a region in which a target subject appears in the spectral sensor image can be specified to some extent, for example, a case where the subject to be targeted in analysis processing based on the narrow-band images is mainly disposed in a specific region within an angle of view of the spectral camera 10, or the like, it is conceivable that a user performs operation on the spectral camera 10 to indicate the region, and for example, the control unit 5 indicates the designated region to the signal processing unit 12 as an image region to be transmitted.

Hereinafter, information of the image region to be transmitted indicated to the signal processing unit 12 in this manner is referred to as “output region indication information”.

Furthermore, in the first embodiment, the signal processing unit 12 determines a wavelength to be thinned out in the thinning output processing according to a predetermined rule. Specifically, in the present example, the wavelength to be thinned out is switched every time the thinning output processing is performed, and a wavelength to be output in each of times of the thinning output processing is sequentially determined according to the predetermined rule.

Specifically, the signal processing unit 12 in the present example determines a wavelength to be thinned out for each time of the thinning output processing (that is, for each frame) by a round robin method.

Here, the signal processing unit 12 performs processing of generating metadata for enabling interpolation of thinned data in the image generation unit 3 on the spectral sensor image reception side and outputting the metadata together with the thinned data.

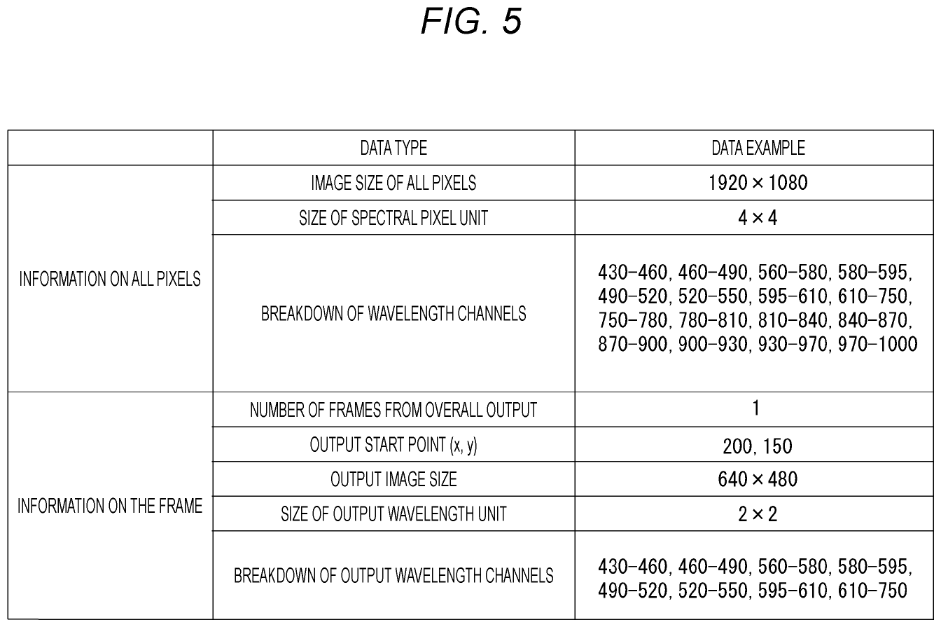

FIG. 5 is an explanatory diagram of an example of the metadata.

In the present example, the metadata is generated as MIPI embedded data corresponding to adoption of the MIPI standard for transmission of the spectral sensor image.

The metadata in the present example roughly includes two pieces of information of “information on all pixels” and “information on the frame”.

The “information on all pixels” includes information of an “image size of all pixels” of the spectral sensor image (for example, 1920×1080 or the like), information of a “size of spectral pixel unit” that is an image size of spectral pixel unit Pu illustrated in FIG. 2 (in the present example, 4×4=16 pixels), and information of a “breakdown of wavelength channels” in the spectral pixel unit Pu (in the present example, λ1 to λ16).

Furthermore, the “information on the frame” includes information of the “number of frames from overall output” indicating the number of frames from a frame on which the overall output processing is performed, information of an “output start point” of the spectral sensor image and information of the “number of output pixels”, information of a “size of output wavelength unit” that is size information of a wavelength unit (output wavelength unit) in an output image, and information of a “breakdown of output wavelength channels” that is a breakdown of wavelengths included in the output wavelength unit.

Here, the information of the “number of frames from overall output” stores “0” in a case where the frame is a frame on which the overall output processing is performed.

Furthermore, the information of the “output start point” stores the uppermost left coordinate (x, y) of an image region to be output. In a case where the overall output processing is performed, (x, y)=(0, 0) is stored as the information of the “output start point”.

Furthermore, the information of the “size of output wavelength unit” stores “2×2” in a case where the wavelength thinning illustrated in FIG. 4 is performed, and the information of the “breakdown of output wavelength channels” stores information corresponding to λ1, λ2, λ5, and λ6 in a case where the wavelength thinning illustrated in FIG. 4 is performed.

In the image generation unit 3 that receives the metadata, as illustrated in FIG. 1 described above, the interpolation unit 34 is provided.

In a frame period in which the overall output processing is performed, the interpolation unit 34 outputs the pixel data of all the regions and all the wavelengths of the spectral sensor image received by the communication unit 31 to the demosaicing unit 32 at the subsequent stage and performs processing of storing the pixel data in the memory unit 35.

Furthermore, in a frame period in which the thinning output processing is performed, the interpolation unit 34 performs interpolation processing on pixel data after thinning received by the communication unit 31 on the basis of the metadata received together with the pixel data after the thinning and the (latest) pixel data of all the regions and all the wavelengths stored in the memory unit 35. Then, pixel data after the interpolation processing (the pixel data after the thinning and pixel data as interpolation data) is output to the demosaicing unit 32.

Here, in a case where spatial thinning is performed, the interpolation unit 34 can specify an image region to be used for interpolation (an image region insufficient for the data after the thinning) from the pixel data of all the regions and all the wavelengths stored in the memory unit 35 on the basis of information of the “image size of all pixels”, the “output start point”, and an “output image size” in the metadata illustrated in FIG. 5.

Furthermore, in a case where the wavelength thinning is performed, the interpolation unit 34 can specify pixel data to be used for interpolation (pixel data of a wavelength insufficient for the data after the thinning) from the pixel data of all the regions and all the wavelengths stored in the memory unit 35 on the basis of at least the information of the “breakdown of wavelength channels” and the “breakdown of output wavelength channels” in the metadata illustrated in FIG. 5.

As described above, the metadata in the present embodiment functions as data indicating interpolation data for the pixel data after the thinning.

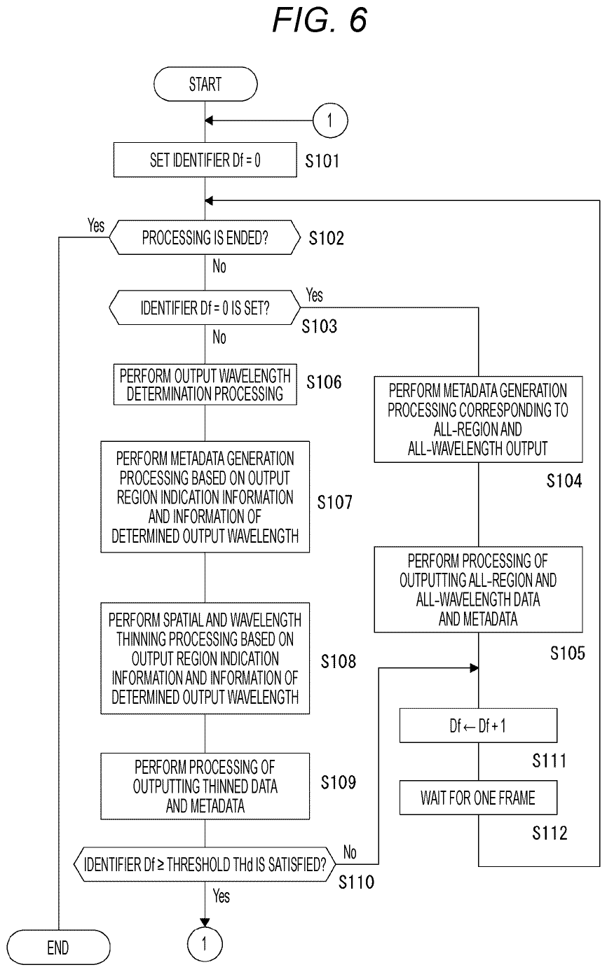

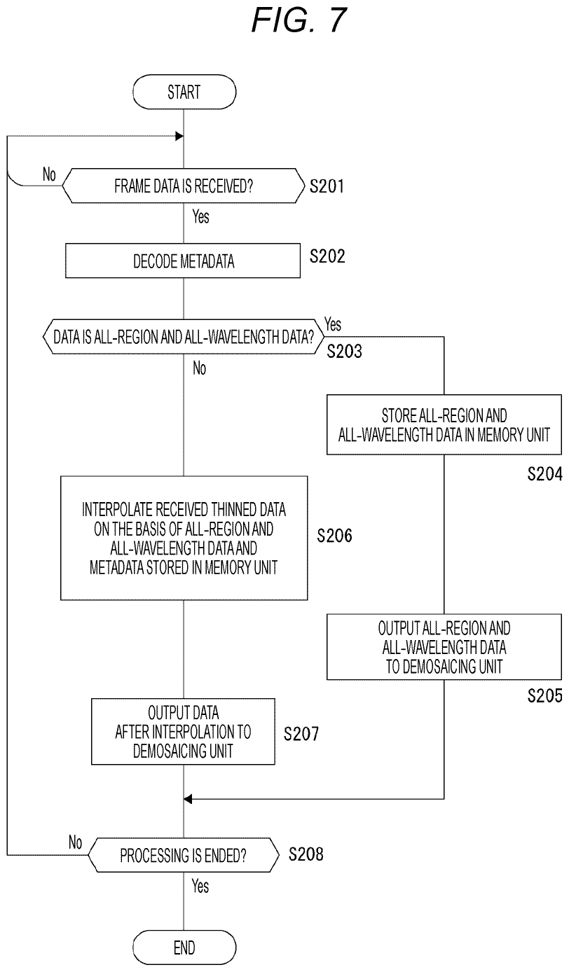

With reference to flowcharts of FIGS. 6 and 7, a description will be given of an example of a processing procedure for implementing the thinning method and the interpolation method as the first embodiment described above.

FIG. 6 is a flowchart illustrating an example of a processing procedure to be executed by the signal processing unit 12 in order to implement the thinning method as the first embodiment.

First, in step S101, the signal processing unit 12 sets, to 0, an identifier Df for identifying which of the overall output processing and the thinning output processing is to be executed for the frame. If the identifier Df=0 is set, the frame is a frame for which the overall output processing is to be executed.

In step S102 subsequent to step S101, the signal processing unit 12 determines whether or not the processing is ended. That is, it is determined whether or not a given condition is satisfied determined in advance as a condition that a series of processing illustrated in FIG. 6 should be ended, for example, a condition that there is an operation stop instruction from the control unit 5, or the like.

In a case where it is determined in step S102 that the given condition is not satisfied and the processing is not ended, the signal processing unit 12 proceeds to step S103 and determines whether or not the identifier Df is 0.

In a case where the identifier Df is 0, the signal processing unit 12 proceeds to step S104 and performs metadata generation processing corresponding to all-region and all-wavelength output. As the metadata in this case, it is only required to generate data indicating that the frame is an overall output processing frame. As a specific example, metadata is generated in which “0” is stored as the “number of frames from overall output”, “(0, 0)” is stored as the “output start point”, the same value as the “image size of all pixels” is stored as the “output image size”, the same value as the “size of spectral pixel unit” is stored as the “size of output wavelength unit”, and the same value as the “breakdown of wavelength channels” is stored as the “breakdown of output wavelength channels” illustrated in FIG. 5.

In step S105 subsequent to step S104, the signal processing unit 12 performs processing of outputting the all-region and all-wavelength data and the metadata. That is, processing is performed of outputting the pixel data of all the regions and all the wavelengths of the spectral sensor image in the frame period and the metadata generated in step S104.

In response to execution of the processing in step S105, the signal processing unit 12 advances the processing to step S111, increments a value of the identifier Df by 1, performs processing of waiting for one frame in step S112, and then returns to step S102 described above.

If the processing is not ended in step S102, it is determined in step S103 whether or not the identifier Df is 0.

In a case where it is determined in step S103 that the identifier Df is not 0, the signal processing unit 12 proceeds to step S106 and performs output wavelength determination processing. The output wavelength determination processing is processing of determining a wavelength to be output in the thinning output processing, and specifically, in the present example, the wavelength to be output is determined by the round robin method described above. Note that determining a wavelength to be output in the thinning output processing is synonymous with determining a wavelength to be thinned out.

In step S107 subsequent to step S106, the signal processing unit 12 performs metadata generation processing based on the output region indication information and information of the determined output wavelength. That is, the metadata is generated in which values according to the image region to be output indicated by the output region indication information are respectively stored as the values of the “output start point” and the “output image size”, and values according to the wavelength to be output determined in step S106 are respectively stored as information of the “size of output wavelength unit” and the “breakdown of output wavelength channels”. At this time, as values of items in “information on all pixels”, the same values as the metadata generated in the metadata generation processing corresponding to the all-region and all-wavelength output in step S104 are respectively stored. Furthermore, as the information of the “number of frames from overall output”, the value of the identifier Df is stored.

In step S108 subsequent to step S107, the signal processing unit 12 performs spatial and wavelength thinning processing based on the output region indication information and the information of the determined output wavelength. That is, for the spectral sensor image in the frame, processing is performed of extracting only the pixel data of the wavelength determined in step S104 in the image region indicated by the output region indication information as the pixel data of the output target.

In step S109 subsequent to step S108, the signal processing unit 12 performs processing of outputting the thinned data and the metadata. That is, processing is performed of outputting the pixel data extracted in step S108 and the metadata generated in step S107.

In step S110 subsequent to step S109, the signal processing unit 12 determines whether or not the identifier Df is greater than or equal to a threshold THd. Here, the threshold THd determines a period for executing the overall output processing, and for example, in a case where the overall output processing is executed at intervals of 9 frames (every 10 frames), the threshold THd is determined as the threshold THd=9. That is, the threshold THd is set as the threshold THd=s if the overall output processing is executed at intervals of s frames.

In a case where it is determined in step S110 that the identifier Df is not greater than or equal to the threshold THd, the signal processing unit 12 advances the processing to step S111 described above. As a result, in a case where the thinning output processing for the predetermined number of frames has not yet been completed, the identifier Df is incremented in step S111, and then the thinning output processing is executed for the spectral sensor image of the next frame.

On the other hand, in a case where it is determined in step S110 that the identifier Df is greater than or equal to the threshold THd, the signal processing unit 12 returns to step S101 and sets the identifier Df to 0 again. As a result, in response to execution of the thinning output processing for the predetermined number of frames after execution of the overall output processing, the overall output processing is executed again.

The signal processing unit 12 ends the series of processing illustrated in FIG. 6 in response to determining that the processing is ended in step S102.

FIG. 7 is a flowchart illustrating an example of a processing procedure to be executed by the interpolation unit 34 in order to implement the interpolation method as the first embodiment.

In step S201, the interpolation unit 34 performs processing of waiting for reception of frame data, that is, processing of waiting for reception of frame data of the spectral sensor image output from the sensor unit 1 side, specifically, pixel data and metadata of the spectral sensor image.

Then, in a case where the frame data is received, the interpolation unit 34 performs processing of decoding the metadata in step S202.

In response to decoding the metadata in step S202, the interpolation unit 34 determines in step S203 whether or not the data is the all-region and all-wavelength data, that is, whether or not the data is the pixel data of all the regions and all the wavelengths output by the overall output processing. Whether or not the received data is the all-region and all-wavelength data can be determined on the basis of whether or not a value of the “number of frames from overall output” in the metadata is “0”.

In a case where it is determined in step S203 that the data is the all-region and all-wavelength data, the interpolation unit 34 proceeds to step S204 to perform processing of storing the all-region and all-wavelength data in the memory unit 35, and then proceeds to step S205 to perform processing of outputting the all-region and all-wavelength data to the demosaicing unit 32.

In response to performing the processing of outputting in step S205, the interpolation unit 34 advances the processing to step S208, and determines whether or not the processing is ended, that is, whether or not a given condition is satisfied determined in advance as a condition that a series of processing illustrated in FIG. 7 should be ended, for example, a condition that there is an operation stop instruction from the control unit 5, or the like.

In a case where it is determined in step S208 that the given condition is not satisfied and the processing is not ended, the interpolation unit 34 returns to step S201.

In a case where it is determined in step S203 described above that the received data is not the all-region and all-wavelength data (that is, in a case where the received data is the thinned data), the interpolation unit 34 advances the processing to step S206.

In step S206, the interpolation unit 34 performs processing of interpolating the received thinned data on the basis of the all-region and all-wavelength data and the metadata stored in the memory unit 35. That is, processing of interpolating the received thinned data is performed on the basis of the latest pixel data of all the regions and all the wavelengths stored in the memory unit 35 and the metadata decoded in step S202.

Then, in subsequent step S207, the interpolation unit 34 performs processing of outputting the interpolated data, that is, the pixel data after the interpolation processing in step S206, to the demosaicing unit 32, and advances the processing to step S208 described above.

The interpolation unit 34 ends the series of processing illustrated in FIG. 7 in response to determining that the processing is ended in step S208.

Here, in the specific example described above, an example has been described in which the signal processing unit 12 determines a wavelength to be output in the thinning output processing, but it is also conceivable to have a configuration in which the wavelength to be output is indicated from the outside of the signal processing unit 12. For example, in an application in which a subject as a target in analysis processing based on narrow-band images generated from a spectral sensor image is mainly limited to a subject of a specific color (for example, tomato or the like), or the like, it is conceivable to have a configuration in which information indicating a wavelength corresponding to the specific color as a wavelength to be output is input from the outside to the signal processing unit 12. In this case, the signal processing unit 12 performs processing of outputting only the pixel data of the wavelength indicated from the outside among the pixel data of all the wavelengths in the spectral sensor image in the thinning output processing.

In this case, it is conceivable that the indication information of the wavelength from the outside is, for example, indication information based on the user's operation, indication information from an application that performs analysis processing based on narrow-band images, or the like.

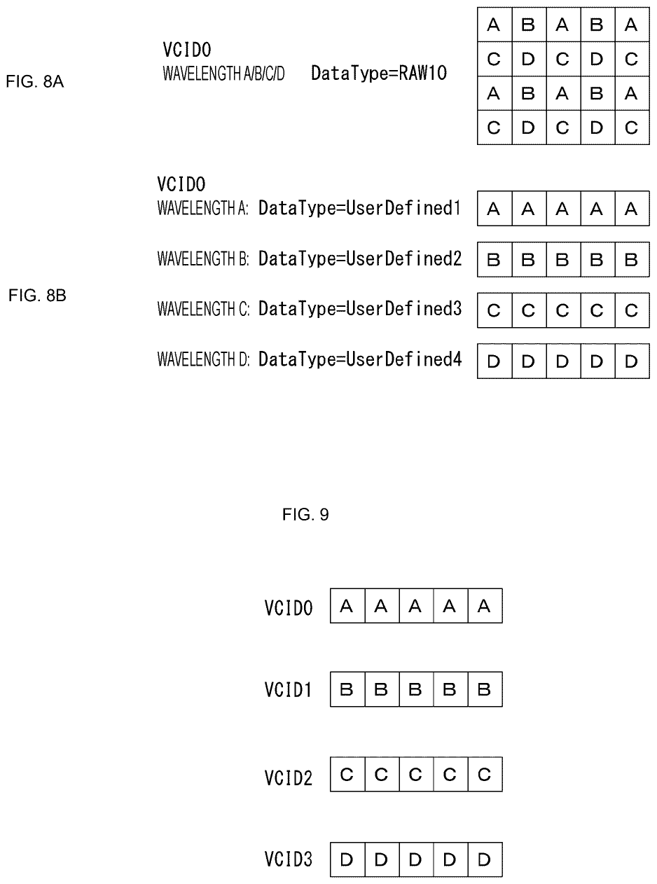

Furthermore, it is conceivable to adopt a transmission method as illustrated in FIGS. 8 and 9, for example, for transmission of the spectral sensor image.

In FIG. 8, FIG. 8A illustrates an example of a case where pixel data of a spectral sensor image is transmitted as one RAW data without being separated for each wavelength.

FIG. 8B illustrates an example of a case where pixel data of a spectral sensor image is separated for each wavelength and transmitted as RAW data for each wavelength. In the case of this example, there is an advantage that it is not necessary to perform processing of separating pixel data for each wavelength on the reception side (image generation unit 3 side).

FIG. 9 illustrates an example in which a virtual channel (VC) in MIPI is used, and wavelengths are separated and transmitted for respective VCs. In the case of this example, if the reception side supports VC, there is an advantage similar to that in the case of FIG. 8B for the reception side.

### 2. Second Embodiment

Next, a second embodiment will be described.

In the second embodiment, spatial thinning of a spectral sensor image is performed such that only pixel data of a region of a moving subject is output in the thinning output processing.

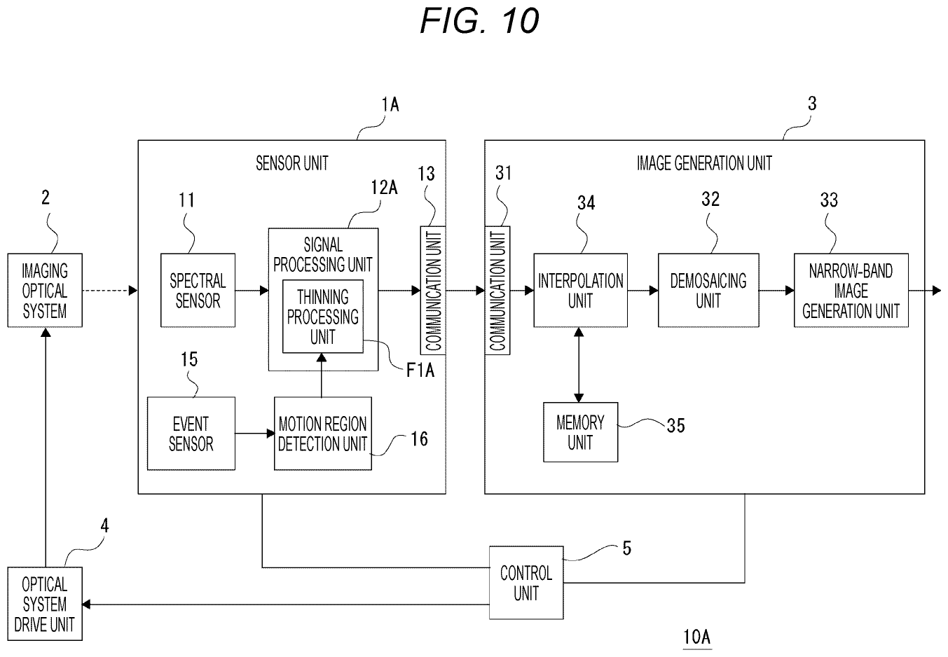

FIG. 10 is a block diagram illustrating a schematic configuration example of a spectral camera 10A as the second embodiment.

Note that, in the following description, parts similar to the already described parts are denoted by the same reference numerals (including step numbers of the processing), and description thereof is omitted.

As compared with the spectral camera 10 of the first embodiment illustrated in FIG. 1, the spectral camera 10A is different in that a sensor unit 1A is provided instead of the sensor unit 1.

As compared with the sensor unit 1, the sensor unit 1A is different in that an event sensor 15 and a motion region detection unit 16 are added, and a signal processing unit 12A is provided instead of the signal processing unit 12.

As compared with the signal processing unit 12, the signal processing unit 12A is different in that a thinning processing unit F1A is included instead of the thinning processing unit F1.

The event sensor 15 is a light receiving sensor called an event based sensor (EVS), and is a sensor in which a plurality of pixels including light receiving elements is two-dimensionally arranged and in each pixel, a change in an amount of received light of a predetermined amount or more is detected as an event.

Note that, although not illustrated, the event sensor 15 is also provided with a corresponding optical system, that is, an optical system for guiding light from a subject to the event sensor 15.

The event sensor 15 is disposed to have a sensing range common to the spectral sensor 11. As a result, the subject captured within an angle of view of the spectral sensor 11 is also captured within an angle of view of the event sensor 15.

The event sensor 15 is configured to output, for each pixel in which an event is detected, information indicating a position of the pixel (event detection pixel position information) and information indicating a detection time of the event (event detection time information). Furthermore, in the event sensor 15, an amount of charge accumulation of the pixel in which the event is detected is reset, and as a result, the pixel in which the event is detected is reset to a state in which event detection can be performed again.

Hereinafter, the event detection pixel position information and the event detection time information output by the event sensor 15 will be referred to as “event detection information”.

The motion region detection unit 16 detects a region of a moving subject on the basis of the event detection information from the event sensor 15.

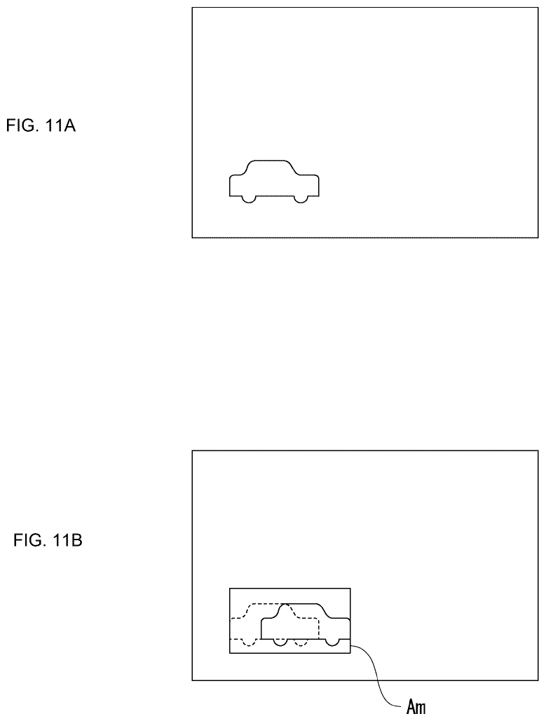

FIG. 11 is a diagram for explaining an example of detection of the region of the moving subject by the motion region detection unit 16.

In a case where the moving subject is present within the angle of view as illustrated as a transition from FIG. 11A to FIG. 11B, the motion region detection unit 16 detects, for example, a region Am including both a subject detection region (a solid line region in FIG. 11B) at the latest detection timing and a subject detection region (a broken line region in FIG. 11B) at an immediately preceding detection timing as the region of the moving subject.

Note that the region of the moving subject is only required to include at least the subject detection region at the latest detection timing.

In the signal processing unit 12A, the thinning processing unit F1A outputs only the pixel data of the region of the moving subject detected by the motion region detection unit 16 among the pixel data of all the pixels of the spectral sensor image in the thinning output processing.

As a result, it is possible to implement efficient data transmission in which only pixel data is transmitted of an image region in which there is a motion, that is, an image region in which there is a change, and pixel data is thinned out of an image region in which there is no change.

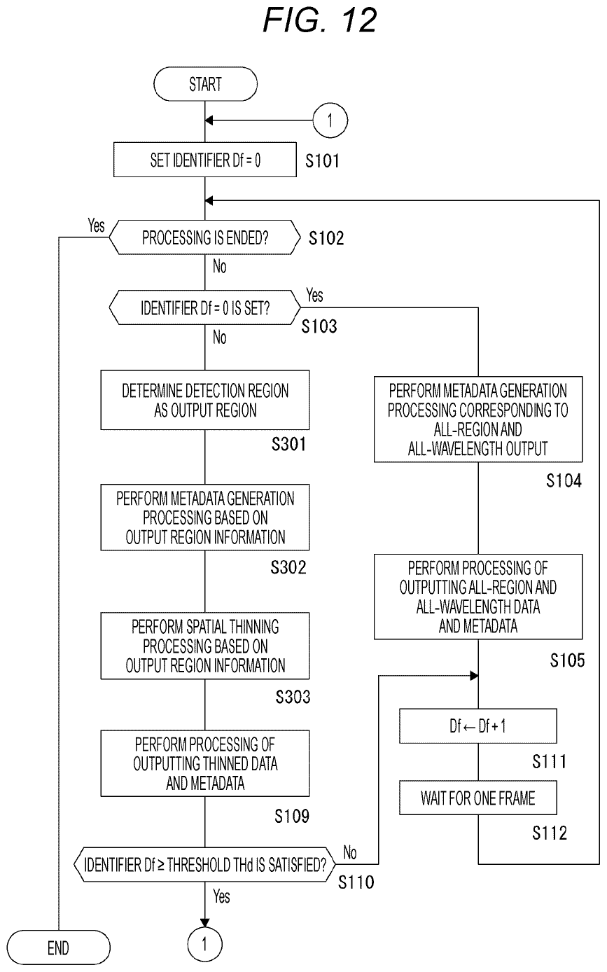

A flowchart of FIG. 12 illustrates an example of a processing procedure to be executed by the signal processing unit 12A in order to implement a thinning method as the second embodiment described above.

As compared with the flowchart of FIG. 6 described above, the processing of the thinning method in this case is different in that pieces of processing of steps S301, S302, and S303 are performed instead of pieces of processing of steps S106, S107, and S108, respectively.

As illustrated, in a case where it is determined in step S103 that the identifier Df is not 0, the signal processing unit 12A advances the processing to step S301 to perform processing of determining the detection region as an output region. That is, processing is performed of determining the region of the moving subject detected by the motion region detection unit 16 as the image region to be output.

In step S302 subsequent to step S301, the signal processing unit 12A performs metadata generation processing based on output region information. That is, the metadata generation processing is based on information of the output region determined in step S301. In the present example, since only spatial thinning based on the region of the moving subject is performed, item information related to the wavelength in the “information on the frame” of the metadata stores the same value as that in the case of performing the overall output processing, and stores values based on the information of the determined output region for the values of the “output start point” and the “output image size”.

In step S303 subsequent to step S302, the signal processing unit 12A performs spatial thinning processing based on the output region information. That is, processing is performed of extracting only the pixel data in the output region determined in step S301 among all the pixels of the spectral sensor image in the frame as the pixel data of the output target.

In response to execution of the thinning processing in step S303, the signal processing unit 12A advances the processing to step S109.

Here, also in the second embodiment, since the processing on the reception side (interpolation unit 34) is similar to that illustrated in FIG. 7, redundant description is avoided.

Note that, in the above, an example has been described in which the event sensor 15 is used to detect the region of the moving subject; however, the sensor for detecting the region of the moving subject is not limited to the event sensor 15, and a normal image sensor can also be used, for example, an RGB sensor, or the like. For example, in the case of using an image sensor, it is conceivable that the region of the moving subject is detected by inter-frame difference detection.

Furthermore, in the above, an example has been described in which the wavelength thinning is not performed in the case of performing the spatial thinning based on the region of the moving subject; however, the wavelength thinning can also be performed in the second embodiment.

Here, in a case where a light receiving sensor (hereinafter referred to as “another sensor”) separate from the spectral sensor 11 is provided as in the second embodiment (including a third embodiment to be described later), it is also conceivable to have a configuration in which operation of generating a spectral sensor image by the spectral sensor 11 is started with detection of motion of a subject as a trigger on the basis of light reception information by the another sensor.

For example, in the configuration of the spectral camera 10A illustrated in FIG. 10, it is conceivable that the signal processing unit 12A performs control to start operation of generating a spectral sensor image by the spectral sensor 11 in response to detection of the region of the moving subject by the motion region detection unit 16.

Note that, in the configuration example, the another sensor used to detect the motion of the subject is not limited to the event sensor 15, and it is conceivable to use a normal image sensor such as an RGB sensor, and in that case, it is conceivable to perform detection of the motion of the subject by inter-frame difference detection.

Since narrow-band image generation processing based on a spectral sensor image requires a large amount of calculation and a large processing time, if a configuration is adopted in which the detection of the motion of the subject based on the narrow-band image is performed and the motion of the subject is detected and then the narrow-band image generation processing is performed, there is a possibility that the narrow-band image generation processing is performed on the basis of the spectral sensor image in a state where the motion of the subject has already stopped. If the configuration is adopted in which the operation of the spectral sensor is started in response to the detection of the motion of the subject based on the light reception information by the another sensor as described above, the narrow-band image generation processing is performed on the basis of the spectral sensor image generated in a state where there is the motion of the subject.

Therefore, it is possible to prevent the narrow-band image generation processing from being executed wastefully for the spectral sensor image generated in a state where there is no motion of the subject, and it is possible to improve efficiency of the narrow-band image generation processing.

### 3. Third Embodiment

In the third embodiment, in the thinning output processing, the number of wavelengths to be thinned out is adjusted on the basis of an amount of detected events by the event sensor 15.

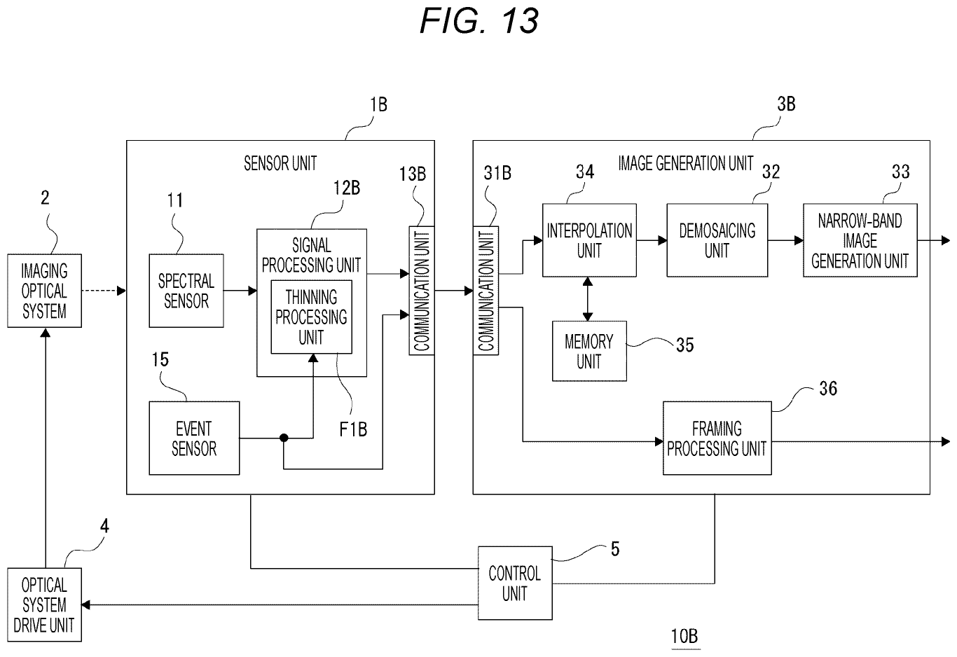

FIG. 13 is a block diagram illustrating a schematic configuration example of a spectral camera 10B as the third embodiment.

As compared with the spectral camera 10A of the second embodiment illustrated in FIG. 10, the spectral camera 10B is different in that a sensor unit 1B is provided instead of the sensor unit 1A, and an image generation unit 3B is provided instead of the image generation unit 3.

As compared with the sensor unit 1A, the sensor unit 1B is different in that the motion region detection unit 16 is omitted, a signal processing unit 12B is provided instead of the signal processing unit 12A, and a communication unit 13B is provided instead of the communication unit 13.

In the sensor unit 1B, in this case as well, the event sensor 15 is disposed to have a sensing range common to the spectral sensor as in the case of the second embodiment.

As compared with the signal processing unit 12A, the signal processing unit 12B is different in that a thinning processing unit F1B is included instead of the thinning processing unit F1A.

As compared with the image generation unit 3, the image generation unit 3B is different in that a communication unit 31B is provided instead of the communication unit 31 and a framing processing unit 36 is provided.

The spectral camera 10B is configured to generate narrow-band images for Mch based on the spectral sensor image and generate an event image based on the event detection information by the event sensor 15.

Specifically, the communication unit 13B in the sensor unit 1B receives, as inputs, the pixel data of the spectral sensor image input from the signal processing unit 12B and the event detection information by the event sensor 15, and serially transmits the pixel data and the event detection information to the communication unit 31B of the image generation unit 3B. The communication unit 31B separates the serially transmitted pixel data and the event detection information from each other, and outputs the pixel data to the interpolation unit 34 and the event detection information to the framing processing unit 36.

The framing processing unit 36 generates an event image by classifying the event detection information in the time axis direction in units of predetermined frame periods on the basis of the event detection time information included in each piece of event detection information. The event image here is generated as an image indicating a two-dimensional distribution of the event detection pixels for each frame period, such as an image in which a pixel value of an event detection pixel in a corresponding frame period is “1” and a pixel value of a non-event detection pixel is “0”.

Here, in a case where a configuration is assumed in which the pixel data of the spectral sensor image and the event detection information are transmitted from the sensor unit 1B to the image generation unit 3B at the subsequent stage through a common transmission path as described above, a band of the transmission path is compressed in a period in which an amount of event detection is large.

Thus, in the third embodiment, the signal processing unit 12B (thinning processing unit F1B) performs processing of determining a wavelength to be thinned out on the basis of the amount of detected events by the event sensor 15 in the thinning output processing.

Specifically, the signal processing unit 12B determines a wavelength to be thinned out so that the amount of detected events by the event sensor 15 and an amount of thinning of the spectral sensor image have a positive correlation.

As a result, in a case where both the pixel data of the spectral sensor image and the event detection information by the event sensor are transmitted on the common transmission path, when the amount of detected events is large, it is possible to reduce an amount of transmission data on the spectral sensor image side by increasing the number of wavelengths to be thinned out, and it is possible to implement adjustment of an amount of thinned data for efficiently using a finite transmission band.

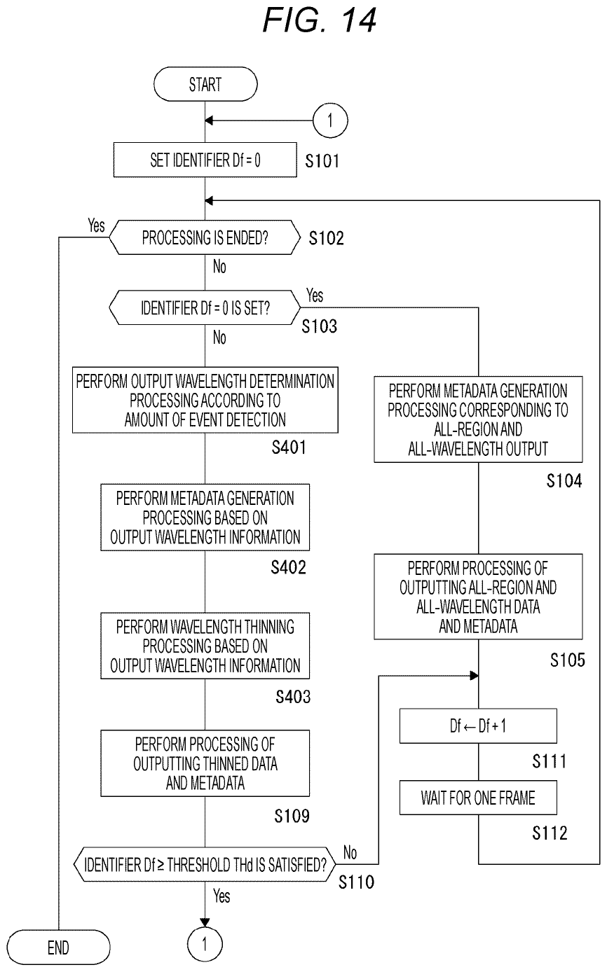

FIG. 14 is a flowchart illustrating an example of a processing procedure to be executed by the signal processing unit 12B in order to implement a thinning method as the third embodiment described above.

As compared with the flowchart of FIG. 6 described above, the processing of the thinning method in this case is different in that pieces of processing of steps S401, S402, and S403 are performed instead of pieces of processing of steps S106, S107, and S108, respectively.

In a case where it is determined in step S103 that the identifier Df is not 0, the signal processing unit 12B advances the processing to step S401 and performs output wavelength determination processing according to the amount of event detection. Specifically, in the present example, processing of determining the wavelength to be output is performed to satisfy a condition that the amount of detected events by the event sensor 15 and the amount of thinning of the spectral sensor image have a positive correlation.

In step S402 subsequent to step S401, the signal processing unit 12B performs metadata generation processing based on the output wavelength information. That is, the metadata generation processing is based on information of the wavelength to be output determined in step S401. In the present example, since only the wavelength thinning is performed according to the amount of detected events, the same values as those in the case of performing the overall output processing are stored for the values of the “output start point” and the “output image size” in the “information of the frame” of the metadata, and values based on the information of the determined wavelength to be output are stored for the values of the “size of output wavelength unit” and the “breakdown of output wavelength channels”.

In step S403 subsequent to step S402, the signal processing unit 12B performs wavelength thinning processing based on the output wavelength information. That is, processing is performed of extracting only the pixel data of the wavelength to be output determined in step S401 among all the pixels of the spectral sensor image in the frame as the pixel data of the output target.

In response to execution of the thinning processing in step S403, the signal processing unit 12B advances the processing to step S109.

Also in the third embodiment, the processing on the reception side (interpolation unit 34) is similar to that illustrated in FIG. 7, and thus redundant description is avoided.

Note that, in the above, an example has been described in which spatial thinning is not performed in the case of performing wavelength thinning based on the amount of detected events; however, spatial thinning can also be performed in the third embodiment.

### 4. Fourth Embodiment

A fourth embodiment relates to AE detection.

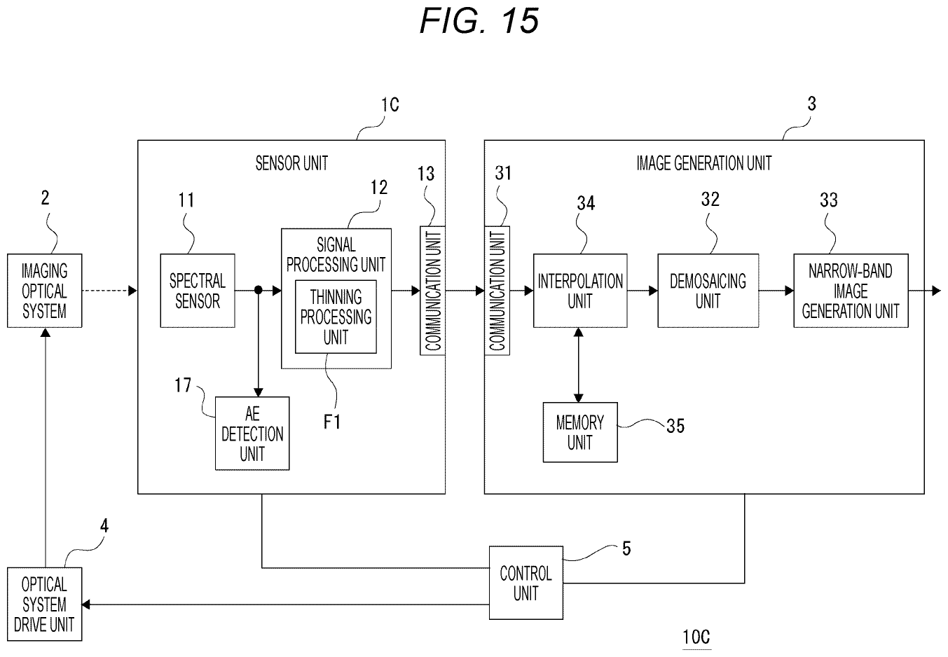

It is conceivable that the AE detection is performed on a spectral sensor image before thinning processing is performed, as in a spectral camera 10C illustrated in FIG. 15, for example.

Specifically, in a sensor unit 1C of the spectral camera 10C, an AE detection unit 17 splits and receives, as an input, the spectral sensor image input from the spectral sensor 11 to the signal processing unit 12, and performs AE detection processing.

As a result, detection accuracy can be improved as compared with a case where detection is performed on data after thinning, and accuracy of AE control can be improved.

Furthermore, in a case where the AE detection is performed, it is also conceivable to exclude an image region within an AE detection frame from a thinning target in the thinning output processing.

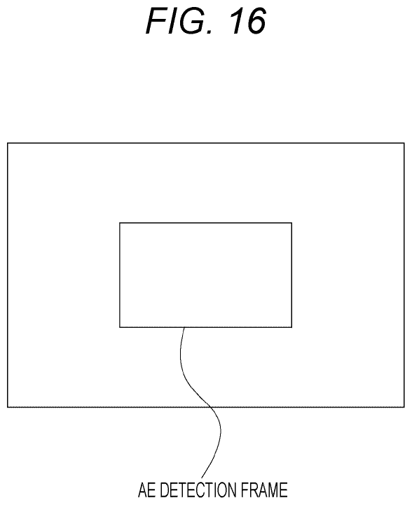

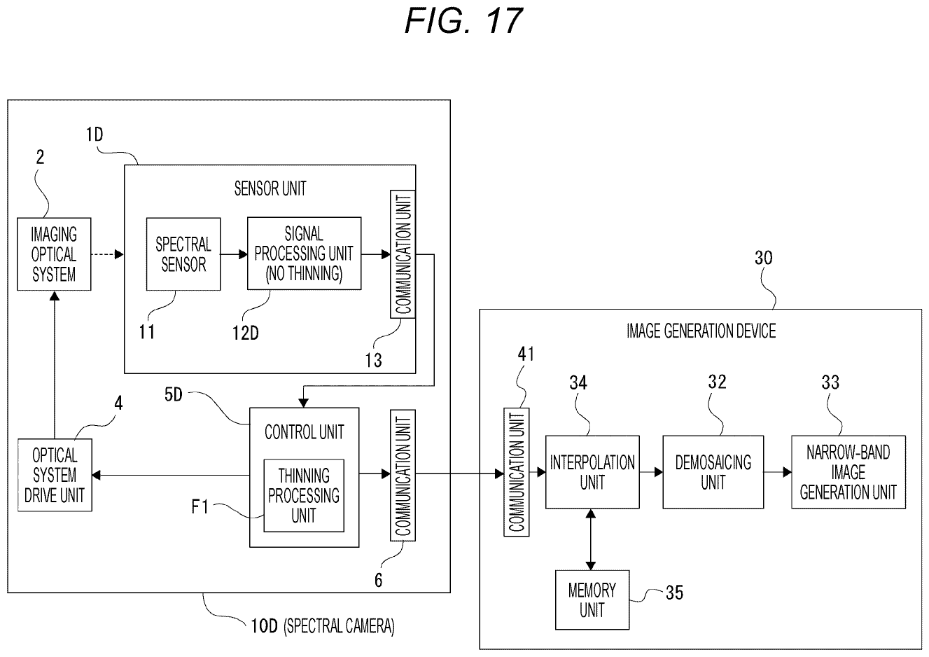

FIG. 16 illustrates an example of the AE detection frame determined for the spectral sensor image.

In the thinning output processing, the signal processing unit 12 in this case excludes an image region within a range of such an AE detection frame from the thinning target, and performs thinning processing on the spectral sensor image. In this case, as the thinning, either wavelength thinning or spatial thinning may be performed.

Furthermore, in a case where it is assumed that wavelength thinning is performed by excluding a specific wavelength from the thinning target in the thinning output processing, it is also conceivable that the AE detection is performed only for pixel data of the specific wavelength.

In a case where the specific wavelength is excluded from the thinning target, since it is assumed that the subject to be analyzed is mainly a subject of a specific color such as tomato, there is no particular problem even if the AE detection is performed only for the pixel data of the specific wavelength as described above.

In this case, since the AE detection can be performed on the thinned pixel data, there is an advantage that the AE detection can be performed at a stage subsequent to the sensor unit 1. That is, there is an advantage that it is not necessary to provide the AE detection unit 17 in the sensor unit 1.

### 5. Modification

Note that the embodiments are not limited to the specific examples described above, and may be configured as various modifications.

For example, in the above, an example has been described in which thinned transmission is performed in one device as a spectral camera, but it is also assumed that the thinned transmission is performed as transmission between devices.

FIG. 17 illustrates an example.

In this case, as the spectral camera, a spectral camera is used of a type not including the image generation unit 3, such as a spectral camera 10D in the drawing. In the spectral camera 10D, instead of the sensor unit 1, a sensor unit 1D is provided including a signal processing unit 12D not having a thinning function as an embodiment, and instead of the control unit 5, a control unit 5D is provided having a function as a thinning processing unit F1.

The control unit 5D receives, as an input, a spectral sensor image through the communication unit 13 in the sensor unit 1D, performs overall output processing at intervals of s frames, and performs thinning output processing in each frame period in which the overall output processing is not performed. The pixel data and the metadata of the spectral sensor image output in each of the overall output processing and the thinning output processing by the control unit 5D are output to an image generation device 30 through a communication unit 6.

Here, the communication unit 6 performs wired or wireless data communication with an external device, and it is conceivable that the communication unit 6 is configured to perform, for example, wired data communication with an external device according to a predetermined wired communication standard such as a universal serial bus (USB) communication standard, wireless data communication with an external device according to a predetermined wireless communication standard such as a Bluetooth (registered trademark) communication standard, or wireless or wired data communication with an external device through a predetermined network such as the Internet.

The image generation device 30 includes a communication unit 41, and also includes the demosaicing unit 32, the narrow-band image generation unit 33, the interpolation unit 34, and the memory unit 35, similarly to the image generation unit 3 and the like described above. The communication unit 41 receives the pixel data and the metadata output from the communication unit 6 of the spectral camera 10D, and outputs the pixel data and the metadata to the interpolation unit 34.

For example, as in the example in FIG. 17, the thinned transmission can be performed as data transmission between devices, and a signal processing device that executes the thinning processing as the embodiment does not necessarily include the interpolation unit 34, the demosaicing unit 32, and the narrow-band image generation unit 33.

Furthermore, a signal processing device that performs the interpolation processing as the embodiment based on the metadata for the data after the thinning does not necessarily include a signal processing unit that performs the thinning processing as the embodiment.

Here, although not specifically mentioned in the above description, it is also conceivable to perform thinning by image size reduction as spatial thinning.

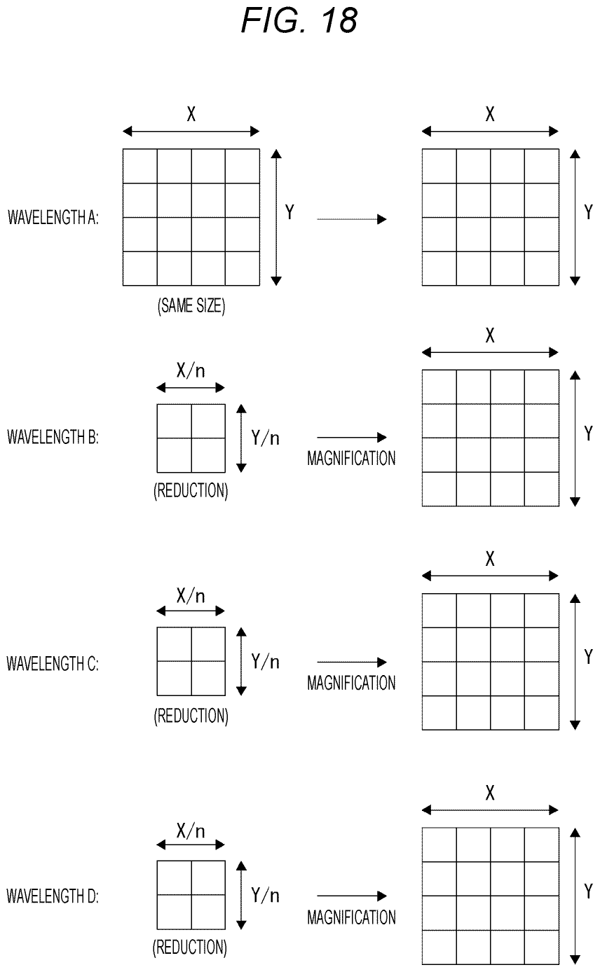

FIG. 18 illustrates an example of performing thinning by image size reduction only for a specific wavelength.

Here, a case is illustrated where the number of spectral pixel units Pu in the horizontal direction of the entire spectral sensor image is X, the number of spectral pixel units Pu in the vertical direction is Y, and reduction of 1/n is performed in each of the horizontal direction and the vertical direction only for wavelengths B to D among wavelengths A to D.

In this case, the reception side performs enlargement processing (pixel interpolation processing) by, for example, linear interpolation, bilinear interpolation, or the like for each of the wavelengths B, C, and D, and restores an original scale.

The amount of transmission data can also be reduced by such thinning by image size reduction.

Note that it is also conceivable that image generation processing (demosaicing processing and narrow-band image generation processing) at the subsequent stage is made common to a plurality of types of the spectral sensors 11 having different numbers or combinations of receiving wavelength channels by using the metadata as illustrated in FIG. 5 described above.

For example, the information of the “breakdown of wavelength channels” in the metadata is made as information defining not only the information of each receiving wavelength channel in the spectral pixel unit Pu but also an arrangement order of each receiving wavelength channel in the spectral pixel unit Pu. Then, the image generation processing at the subsequent stage is made as processing capable of executing corresponding demosaicing processing or narrow-band image generation processing on the basis of the information of the “breakdown of wavelength channels” for any pattern of the number or combination of the receiving wavelength channels. As a result, the image generation processing at the subsequent stage can be made common to the plurality of types of the spectral sensors 11 having different numbers or combinations of receiving wavelength channels.

### 6. Program

As an embodiment, it is possible to consider a program for causing, for example, a CPU, a digital signal processor (DSP), or the like, or a device including the CPU, the DSP, or the like to implement functions of the signal processing units 12, 12A, and 12B described above with reference to FIGS. 6, 12, 14, and the like.

That is, the program of the embodiment is a program that can be read by a computer device, and causes the computer device to implement a function of performing, for a spectral sensor image that is a spectral image obtained by light receiving operation of a spectral sensor, overall output processing of outputting pixel data of all regions and all wavelengths for a spectral sensor image obtained in a first frame period, and thinning output processing of thinning out and outputting part of pixel data for the spectral sensor image obtained in a second frame period different from the first frame period.

With such a program, the functions of the signal processing units 12, 12A, 12B, and the like described above can be implemented in a device as the spectral camera 10 or the like.

The program described above can be recorded in advance in a hard disk drive (HDD) as a recording medium built in a device such as a computer device, ROM in a microcomputer including a CPU, or the like.

Alternatively, the program may be temporarily or permanently stored (recorded) in a removable recording medium such as a flexible disk, a compact disc read only memory (CD-ROM), a magneto optical (MO) disk, a digital versatile disc (DVD), a Blu-ray disc (registered trademark), a magnetic disk, a semiconductor memory, or a memory card. Such a removable recording medium can be provided as so-called package software.

Furthermore, such a program can be installed from the removable recording medium into a personal computer and the like, or can be downloaded from a download site through a network such as a local area network (LAN) or the Internet.

Furthermore, such a program is suitable for a wide range of provision of the thinning methods as the embodiments. For example, by downloading the program to a personal computer, a portable information processing device, a mobile phone, a game device, a video device, a personal digital assistant (PDA), or the like, the personal computer or the like can be caused to function as a device that implements the thinning methods of the present disclosure.

### 7. Summary of Embodiments

As described above, a first signal processing device (the sensor units 1, 1A, 1B, 1C, the spectral camera 10D) as an embodiment includes a signal processing unit (the signal processing units 12, 12A, 12B, the control unit 5D) that performs, for a spectral sensor image that is a spectral image obtained by light receiving operation of a spectral sensor (the spectral sensor 11), overall output processing of outputting pixel data of all regions and all wavelengths for a spectral sensor image obtained in a first frame period, and thinning output processing of thinning out and outputting part of pixel data for the spectral sensor image obtained in a second frame period different from the first frame period.

By performing the thinning output processing described above, it is possible to reduce the amount of transmission data of the spectral sensor image. At this time, by performing the overall output processing described above, it is possible to cause a spectral sensor image reception side to execute interpolation of thinned data by using the pixel data of all the regions and all the wavelengths transmitted in the overall output processing.

As described above, according to the present embodiment, since the thinned transmission of the spectral sensor image can be implemented while enabling the interpolation of the thinned data on the reception side, transmission efficiency of the spectral sensor image can be improved.

Furthermore, in the first signal processing device as the embodiment, the signal processing unit performs wavelength thinning as the thinning.

As a result, it is possible to reduce the amount of transmitted data by outputting image data for only some of the wavelengths, instead of transmitting the pixel data for all the wavelengths.

Moreover, in the first signal processing device as the embodiment, the signal processing unit determines a wavelength to be thinned out for each frame by a round robin method.

As a result, the wavelengths to be thinned out can be switched in order.

Furthermore, in the first signal processing device as the embodiment, the signal processing unit outputs only pixel data of a wavelength externally indicated among pixel data of all wavelengths in the thinning output processing.

As a result, the pixel data can be output every frame for a specific wavelength externally indicated.

Therefore, the interpolation processing can be made unnecessary for the specific wavelength, and accuracy of a narrow-band image related to the specific wavelength can be improved.

For example, in a case where a wavelength to be analyzed is determined as a specific wavelength, the specific wavelength is indicated, whereby analysis accuracy can be improved.

Furthermore, in the first signal processing device as the embodiment, the signal processing unit (the signal processing unit 12B) performs, in the thinning output processing, processing of determining a wavelength to be thinned out on the basis of the amount of detected events by an event sensor disposed to have a sensing range common to the spectral sensor.

As a result, in a case where both the pixel data of the spectral sensor image and the event detection information by the event sensor are transmitted on the common transmission path, it is possible to implement adjustment of the amount of thinned data for efficiently using a finite transmission band, such as increasing the number of wavelengths to be thinned out to reduce the amount of transmission data on the spectral sensor image side when the amount of detected events is large.

Moreover, in the first signal processing device as the embodiment, the signal processing unit performs spatial thinning as the thinning.

That is, only pixel data at some positions of all the pixel data is output.

As a result, the amount of transmission data can be reduced.

Furthermore, the first signal processing device as the embodiment includes a motion region detection unit (the motion region detection unit 16) that detects a region of a moving subject on the basis of light reception information by another sensor that is a light receiving sensor disposed to have a sensing range common to the spectral sensor, and the signal processing unit (the signal processing unit 12A) outputs only pixel data of the region of the moving subject in pixel data of all pixels in the spectral sensor image in the thinning output processing.

As a result, it is possible to implement efficient data transmission in which only pixel data is transmitted of an image region in which there is a motion, that is, an image region in which there is a change, and pixel data is thinned out of an image region in which there is no change.

Furthermore, in the first signal processing device as the embodiment, the signal processing unit performs thinning by image size reduction as the spatial thinning (see FIG. 18).

The amount of transmission data can also be reduced by the thinning by image size reduction.

Moreover, the first signal processing device as the embodiment includes a motion detection unit (the motion region detection unit 16) that detects motion of a subject on the basis of light reception information by another sensor that is a light receiving sensor disposed to have a sensing range common to the spectral sensor, and the signal processing unit performs control to start operation of generating the spectral sensor image by the spectral sensor in response to detection of the motion of the subject by the motion detection unit (see the second embodiment).

Since the narrow-band image generation processing based on a spectral sensor image requires a large amount of calculation and a large processing time, if a configuration is adopted in which the detection of the motion of the subject based on the narrow-band image is performed and the motion of the subject is detected and then the narrow-band image generation processing is performed, there is a possibility that the narrow-band image generation processing is performed on the basis of the spectral sensor image in a state where the motion of the subject has already stopped. The configuration is adopted in which the operation of the spectral sensor is started in response to the detection of the motion of the subject based on the light reception information by the another sensor as described above, whereby the narrow-band image generation processing is performed on the basis of the spectral sensor image generated in a state where there is the motion of the subject.

Therefore, it is possible to prevent the narrow-band image generation processing from being executed wastefully for the spectral sensor image generated in a state where there is no motion of the subject, and it is possible to improve efficiency of the narrow-band image generation processing.

Furthermore, in the first signal processing device as the embodiment, detection processing for automatic exposure control of the spectral sensor is performed on the spectral sensor image before the thinning is performed (see FIG. 15).

As a result, detection accuracy can be improved as compared with a case where detection is performed on data after thinning, and accuracy of automatic exposure control can be improved.

Furthermore, in the first signal processing device as the embodiment, the signal processing unit performs the thinning by excluding a detection region for automatic exposure control of the spectral sensor determined for the spectral sensor image, from the thinning target (see FIG. 16).

As a result, the accuracy of the automatic exposure control can be improved.

Furthermore, in the first signal processing device as the embodiment, the signal processing unit generates metadata indicating interpolation data for pixel data after thinning, and outputs the metadata together with the pixel data after the thinning (see FIG. 5, FIG. 6, FIG. 12, FIG. 14, and the like).

By outputting the metadata as described above, it is possible to cause a reception device for the thinned data to execute interpolation of the thinned data based on the metadata.

A first signal processing method as an embodiment is a signal processing method that performs, for a spectral sensor image that is a spectral image obtained by light receiving operation of a spectral sensor, overall output processing of outputting pixel data of all regions and all wavelengths for a spectral sensor image obtained in a first frame period, and thinning output processing of thinning out and outputting part of pixel data for the spectral sensor image obtained in a second frame period different from the first frame period.

Also with such a first signal processing method, it is possible to achieve functions and effects similar to those of the first signal processing device as the embodiment described above.

Furthermore, a program as an embodiment is a program that can be read by a computer device, and causes the computer device to implement a function of performing, for a spectral sensor image that is a spectral image obtained by light receiving operation of a spectral sensor, overall output processing of outputting pixel data of all regions and all wavelengths for a spectral sensor image obtained in a first frame period, and thinning output processing of thinning out and outputting part of pixel data for the spectral sensor image obtained in a second frame period different from the first frame period.

With such a program, the first signal processing device as the embodiment described above can be implemented.

A second signal processing device (the image generation units 3, 3B, the image generation device 30) as an embodiment includes: a reception unit (the communication units 31, 31B, the communication unit 41) that receives pixel data of all regions and all wavelengths output in overall output processing and pixel data after thinning and metadata output in thinning output processing from a signal processing device that performs, for a spectral sensor image that is a spectral image obtained by light receiving operation of a spectral sensor, the overall output processing of outputting the pixel data of all the regions and all the wavelengths for the spectral sensor image obtained in a first frame period, and the thinning output processing of thinning out and outputting part of pixel data for the spectral sensor image obtained in a second frame period different from the first frame period and outputting metadata indicating interpolation data for the pixel data after the thinning as the metadata of the pixel data after the thinning; and an interpolation unit (the interpolation unit 34) that performs interpolation processing on the pixel data after the thinning on the basis of the pixel data of all the regions and all the wavelengths and the metadata received by the reception unit.

As a result, it is possible to perform interpolation of thinned data corresponding to a case where the pixel data of the spectral sensor image is thinned to reduce the amount of transmission data.

Therefore, the thinned transmission of the spectral sensor image can be implemented while enabling the interpolation of the thinned data on the reception side, and the transmission efficiency of the spectral sensor image can be improved.

Furthermore, in the second signal processing device as the embodiment, in the thinning output processing, wavelength thinning is performed as the thinning, and the interpolation unit interpolates pixel data of a wavelength that is insufficient for the pixel data after the thinning received by the reception unit from the pixel data of all the regions and all the wavelengths received by the reception unit on the basis of the metadata.

As a result, it is possible to appropriately interpolate thinned data corresponding to a case where wavelength thinning is performed.

A second signal processing method as an embodiment includes: receiving pixel data of all regions and all wavelengths output in overall output processing and pixel data after thinning and metadata output in thinning output processing from a signal processing device that performs, for a spectral sensor image that is a spectral image obtained by light receiving operation of a spectral sensor, the overall output processing of outputting the pixel data of all the regions and all the wavelengths for the spectral sensor image obtained in a first frame period, and the thinning output processing of thinning out and outputting part of pixel data for the spectral sensor image obtained in a second frame period different from the first frame period and outputting metadata indicating interpolation data for the pixel data after the thinning as the metadata of the pixel data after the thinning; and performing interpolation processing on the pixel data after the thinning on the basis of the pixel data of all the regions and all the wavelengths and the metadata received.

Also with such a second signal processing method, it is possible to achieve functions and effects similar to those of the second signal processing device as the embodiment described above.

Note that, the effects described in the present specification are merely examples and are not limited, and other effects may be provided.

### 8. Present Technology

The present technology can also adopt the following configurations.

(1)

A signal processing device including
a signal processing unit that performs, for a spectral sensor image that is a spectral image obtained by light receiving operation of a spectral sensor, overall output processing of outputting pixel data of all regions and all wavelengths for the spectral sensor image obtained in a first frame period, and thinning output processing of thinning out and outputting part of pixel data for the spectral sensor image obtained in a second frame period different from the first frame period.
   (2)

The signal processing device according to (1), in which
the signal processing unit performs wavelength thinning as the thinning.
   (3)

The signal processing device according to (2), in which
the signal processing unit determines a wavelength to be thinned out for each of frames by a round robin method.
   (4)

The signal processing device according to (2), in which
the signal processing unit outputs only pixel data of a wavelength externally indicated among pixel data of all wavelengths in the thinning output processing.
   (5)

The signal processing device according to (2), in which
the signal processing unit, in the thinning output processing,
performs processing of determining a wavelength to be thinned out on the basis of an amount of detected events by an event sensor disposed to have a sensing range common to the spectral sensor.
   (6)

The signal processing device according to any of (1) to (5), in which
the signal processing unit performs spatial thinning as the thinning.
   (7)

The signal processing device according to (6), further including
a motion region detection unit that detects a region of a moving subject on the basis of light reception information by another sensor that is a light receiving sensor disposed to have a sensing range common to the spectral sensor, in which
the signal processing unit outputs only pixel data of the region of the moving subject in pixel data of all pixels in the spectral sensor image in the thinning output processing.
   (8)

The signal processing device according to (6), in which
the signal processing unit performs thinning by image size reduction as the spatial thinning.
   (9) The signal processing device according to any of (1) to (8), further including
a motion detection unit that detects motion of a subject on the basis of light reception information by another sensor that is a light receiving sensor disposed to have a sensing range common to the spectral sensor, in which
the signal processing unit
performs control to start operation of generating the spectral sensor image by the spectral sensor in response to detection of the motion of the subject by the motion detection unit.
   (10)

The signal processing device according to any of (1) to (9), in which
detection processing for automatic exposure control of the spectral sensor is performed on the spectral sensor image before the thinning is performed.
   (11)

The signal processing device according to any of (1) to (10), in which
the signal processing unit performs the thinning by excluding a detection region for automatic exposure control of the spectral sensor determined for the spectral sensor image from a thinning target.
   (12)

The signal processing device according to any of (1) to (11), in which
the signal processing unit
generates metadata indicating interpolation data for pixel data after thinning, and outputs the metadata together with the pixel data after the thinning.
   (13)

A signal processing method including:
performing, for a spectral sensor image that is a spectral image obtained by light receiving operation of a spectral sensor, overall output processing of outputting pixel data of all regions and all wavelengths for the spectral sensor image obtained in a first frame period, and thinning output processing of thinning out and outputting part of pixel data for the spectral sensor image obtained in a second frame period different from the first frame period.
   (14)

A program readable by a computer device,
the program
causing the computer device to implement a function of performing, for a spectral sensor image that is a spectral image obtained by light receiving operation of a spectral sensor, overall output processing of outputting pixel data of all regions and all wavelengths for the spectral sensor image obtained in a first frame period, and thinning output processing of thinning out and outputting part of pixel data for the spectral sensor image obtained in a second frame period different from the first frame period.
   (15)

A signal processing device including:
a reception unit that receives pixel data of all regions and all wavelengths output in overall output processing and pixel data after thinning and metadata output in thinning output processing from a signal processing device that performs, for a spectral sensor image that is a spectral image obtained by light receiving operation of a spectral sensor, the overall output processing of outputting the pixel data of all the regions and all the wavelengths for the spectral sensor image obtained in a first frame period, and the thinning output processing of thinning out and outputting part of pixel data for the spectral sensor image obtained in a second frame period different from the first frame period and outputting metadata indicating interpolation data for the pixel data after the thinning as the metadata of the pixel data after the thinning; and
an interpolation unit that performs interpolation processing on the pixel data after the thinning on the basis of the pixel data of all the regions and all the wavelengths and the metadata received by the reception unit.
   (16)

The signal processing device according to (15), in which
in the thinning output processing, wavelength thinning is performed as the thinning, and
the interpolation unit interpolates pixel data of a wavelength that is insufficient for the pixel data after the thinning received by the reception unit from the pixel data of all the regions and all the wavelengths received by the reception unit on the basis of the metadata.
   (17)

A signal processing method including:
receiving pixel data of all regions and all wavelengths output in overall output processing and pixel data after thinning and metadata output in thinning output processing from a signal processing device that performs, for a spectral sensor image that is a spectral image obtained by light receiving operation of a spectral sensor, the overall output processing of outputting the pixel data of all the regions and all the wavelengths for the spectral sensor image obtained in a first frame period, and the thinning output processing of thinning out and outputting part of pixel data for the spectral sensor image obtained in a second frame period different from the first frame period and outputting metadata indicating interpolation data for the pixel data after the thinning as the metadata of the pixel data after the thinning; and
performing interpolation processing on the pixel data after the thinning on the basis of the pixel data of all the regions and all the wavelengths and the metadata received.

### REFERENCE SIGNS LIST

1, 1A, 1B, 1C, 1D Sensor unit
11 Spectral sensor
11a Pixel array unit
12, 12A, 12B, 12D Signal processing unit
F1, F1A, F1B, F1D Thinning processing unit
13, 13B Communication unit
2 Imaging optical system
3, 3B Image generation unit
31, 31B Communication unit
32 Demosaicing unit
33 Narrow-band image generation unit
34 Interpolation unit
35 Memory unit
4 Optical system drive unit
5, 5D Control unit
10, 10A, 10B, 10C, 10D Spectral camera
Px Pixel
Pu Spectral pixel unit
15 Event sensor
16 Motion region detection unit
Am Region
36 Framing processing unit
17 AE detection unit
30 Image generation device
6, 41 Communication unit

1. A signal processing device comprising
a signal processing unit that performs, for a spectral sensor image that is a spectral image obtained by light receiving operation of a spectral sensor, overall output processing of outputting pixel data of all regions and all wavelengths for the spectral sensor image obtained in a first frame period, and thinning output processing of thinning out and outputting part of pixel data for the spectral sensor image obtained in a second frame period different from the first frame period.

2. The signal processing device according to claim 1, wherein
the signal processing unit performs wavelength thinning as the thinning.

3. The signal processing device according to claim 2, wherein
the signal processing unit determines a wavelength to be thinned out for each of frames by a round robin method.

4. The signal processing device according to claim 2, wherein
the signal processing unit outputs only pixel data of a wavelength externally indicated among pixel data of all wavelengths in the thinning output processing.

5. The signal processing device according to claim 2, wherein
the signal processing unit, in the thinning output processing,
performs processing of determining a wavelength to be thinned out on a basis of an amount of detected events by an event sensor disposed to have a sensing range common to the spectral sensor.

6. The signal processing device according to claim 1, wherein
the signal processing unit performs spatial thinning as the thinning.

7. The signal processing device according to claim 6, further comprising
a motion region detection unit that detects a region of a moving subject on a basis of light reception information by another sensor that is a light receiving sensor disposed to have a sensing range common to the spectral sensor, wherein
the signal processing unit outputs only pixel data of the region of the moving subject in pixel data of all pixels in the spectral sensor image in the thinning output processing.

8. The signal processing device according to claim 6, wherein
the signal processing unit performs thinning by image size reduction as the spatial thinning.

9. The signal processing device according to claim 1, further comprising
a motion detection unit that detects motion of a subject on a basis of light reception information by another sensor that is a light receiving sensor disposed to have a sensing range common to the spectral sensor, wherein
the signal processing unit
performs control to start operation of generating the spectral sensor image by the spectral sensor in response to detection of the motion of the subject by the motion detection unit.

10. The signal processing device according to claim 1, wherein
detection processing for automatic exposure control of the spectral sensor is performed on the spectral sensor image before the thinning is performed.

11. The signal processing device according to claim 1, wherein
the signal processing unit performs the thinning by excluding a detection region for automatic exposure control of the spectral sensor determined for the spectral sensor image from a thinning target.

12. The signal processing device according to claim 1, wherein
the signal processing unit
generates metadata indicating interpolation data for pixel data after thinning, and outputs the metadata together with the pixel data after the thinning.

13. A signal processing method comprising:
performing, for a spectral sensor image that is a spectral image obtained by light receiving operation of a spectral sensor, overall output processing of outputting pixel data of all regions and all wavelengths for the spectral sensor image obtained in a first frame period, and thinning output processing of thinning out and outputting part of pixel data for the spectral sensor image obtained in a second frame period different from the first frame period.

14. A program readable by a computer device,
the program
causing the computer device to implement a function of performing, for a spectral sensor image that is a spectral image obtained by light receiving operation of a spectral sensor, overall output processing of outputting pixel data of all regions and all wavelengths for the spectral sensor image obtained in a first frame period, and thinning output processing of thinning out and outputting part of pixel data for the spectral sensor image obtained in a second frame period different from the first frame period.

15. A signal processing device comprising:
a reception unit that receives pixel data of all regions and all wavelengths output in overall output processing and pixel data after thinning and metadata output in thinning output processing from a signal processing device that performs, for a spectral sensor image that is a spectral image obtained by light receiving operation of a spectral sensor, the overall output processing of outputting the pixel data of all the regions and all the wavelengths for the spectral sensor image obtained in a first frame period, and the thinning output processing of thinning out and outputting part of pixel data for the spectral sensor image obtained in a second frame period different from the first frame period and outputting metadata indicating interpolation data for the pixel data after the thinning as the metadata of the pixel data after the thinning; and
an interpolation unit that performs interpolation processing on the pixel data after the thinning on a basis of the pixel data of all the regions and all the wavelengths and the metadata received by the reception unit.

16. The signal processing device according to claim 15, wherein
in the thinning output processing, wavelength thinning is performed as the thinning, and
the interpolation unit interpolates pixel data of a wavelength that is insufficient for the pixel data after the thinning received by the reception unit from the pixel data of all the regions and all the wavelengths received by the reception unit on a basis of the metadata.

17. A signal processing method comprising:
receiving pixel data of all regions and all wavelengths output in overall output processing and pixel data after thinning and metadata output in thinning output processing from a signal processing device that performs, for a spectral sensor image that is a spectral image obtained by light receiving operation of a spectral sensor, the overall output processing of outputting the pixel data of all the regions and all the wavelengths for the spectral sensor image obtained in a first frame period, and the thinning output processing of thinning out and outputting part of pixel data for the spectral sensor image obtained in a second frame period different from the first frame period and outputting metadata indicating interpolation data for the pixel data after the thinning as the metadata of the pixel data after the thinning; and
performing interpolation processing on the pixel data after the thinning on a basis of the pixel data of all the regions and all the wavelengths and the metadata received.
